(19) United States
(12) Patent Application Publication
(10) Pub. No.: US 2023/0402940 A1
(43) Pub. Date: Dec. 14, 2023

(54) SEMICONDUCTOR MODULE AND POWER CONVERTER

(71) Applicant: FUJI ELECTRIC CO., LTD., Kawasaki-shi, Kanagawa (JP)

(72) Inventor: Taku TAKAKU, Matsumoto-city (JP)

(73) Assignee: FUJI ELECTRIC CO., LTD., Kawasaki-shi, Kanagawa (JP)

(21) Appl. No.: 18/321,468

(22) Filed: May 22, 2023

(30) Foreign Application Priority Data
Jun. 10, 2022 (JP) 2022-094552

(51) Int. Cl. H02M 7/537; H02M 7/487

(52) U.S. Cl. CPC H02M 7/537; H02M 7/487

(57) ABSTRACT

A semiconductor module, including a converter circuit configured to generate an alternating-current (AC) voltage from a direct-current (DC) voltage input thereto, by receiving a first potential that is positive, a second potential that is negative, and a third potential lower than the first potential and higher than the second potential. The converter circuit includes a plurality of parallel connection structures, each parallel connection structure including an insulated gate bipolar transistors (IGBT) and a diode device connected in parallel. At least one of the parallel connection structures includes a reverse conducting IGBT.

### CROSS-REFERENCE TO RELATED APPLICATION

The present application claims priority pursuant to 35 U.S.C. § 119 from Japanese patent application number 2022-094552 filed on Jun. 10, 2022, the entire disclosure of which is hereby incorporated by reference herein.

### BACKGROUND

### Technical Field

The present disclosure relates to a semiconductor module and a power converter.

### Description of the Related Art

As a converter circuit that outputs an alternating-current (AC) voltage from a direct-current (DC) voltage divided into a plurality of parts, there have been known a so-called neutral point clamped circuit (NPC circuit) and an active neutral point clamped circuit (ANPC circuit) (for example, Japanese Patent Application Publication No. 2015-006055).

In the NPC circuit and the ANPC circuit, voltages applied to devices such as IGBTs and diode devices included in the circuits and currents flowing therethrough are not uniform, thus likely leading to temperature variations between the devices. If there are temperature variations between the devices, a maximum output current is likely to be limited by a device that has exceeded a maximum junction temperature.

### SUMMARY

An aspect of the present disclosure to achieve the above objective is a semiconductor module comprising: a converter circuit configured to generate an alternating-current (AC) voltage from a direct-current (DC) voltage input thereto, by receiving a first potential that is positive, a second potential that is negative, and a third potential lower than the first potential and higher than the second potential, wherein the converter circuit includes a plurality of parallel connection structures, each parallel connection structure including an insulated gate bipolar transistors (IGBT) and a diode device connected in parallel, and at least one of the parallel connection structures includes a reverse conducting IGBT.

Another aspect of the present disclosure to achieve the above objective is a power converter comprising the semiconductor module comprising: a converter circuit configured to generate an alternating-current (AC) voltage from a direct-current (DC) voltage input thereto, by receiving a first potential that is positive, a second potential that is negative, and a third potential lower than the first potential and higher than the second potential, wherein the converter circuit includes a plurality of parallel connection structures, each parallel connection structure including an insulated gate bipolar transistors (IGBT) and a diode device connected in parallel, and at least one of the parallel connection structures includes a reverse conducting IGBT.

Other features of the present disclosure will become apparent from descriptions of the present specification.

### BRIEF DESCRIPTION OF THE DRAWINGS

FIG. 1 is a diagram illustrating a configuration of a power converter 1 according to an embodiment.

FIGS. 2A to 2F are diagrams illustrating a PWM1 control mode according to the embodiment.

FIGS. 3A to 3E are diagrams illustrating operations of a converter circuit 100u according to the embodiment.

FIGS. 4A to 4E are diagrams illustrating the operations of the converter circuit 100u according to the embodiment.

FIGS. 5A to 5E are diagrams illustrating the operations of the converter circuit 100u according to the embodiment.

FIGS. 6A to 6E are diagrams illustrating the operations of the converter circuit 100u according to the embodiment.

FIG. 7 is a diagram illustrating a configuration of a general power converter 4.

FIGS. 8A to 8D are diagrams illustrating thermal simulation results of a semiconductor module 10.

FIG. 9 is a diagram illustrating a configuration of a power converter 2 according to an embodiment.

FIGS. 10A to 10F are diagrams illustrating a PWM2 control mode according to the embodiment.

FIGS. 11A to 11E are diagrams illustrating operations of a converter circuit 200u according to the embodiment.

FIGS. 12A to 12E are diagrams illustrating the operations of the converter circuit 200u according to the embodiment.

FIGS. 13A to 13E are diagrams illustrating the operations of the converter circuit 200u according to the embodiment.

FIGS. 14A to 14E are diagrams illustrating the operations of the converter circuit 200u according to the embodiment.

FIGS. 15A to 15D are diagrams illustrating thermal simulation results of a semiconductor module 20.

FIG. 16 is a diagram illustrating a configuration of a power converter 3 according to an embodiment.

FIGS. 17A to 17D are diagrams illustrating thermal simulation results of a semiconductor module 30.

### DETAILED DESCRIPTION

### First Embodiment

### <<Power Converter>>

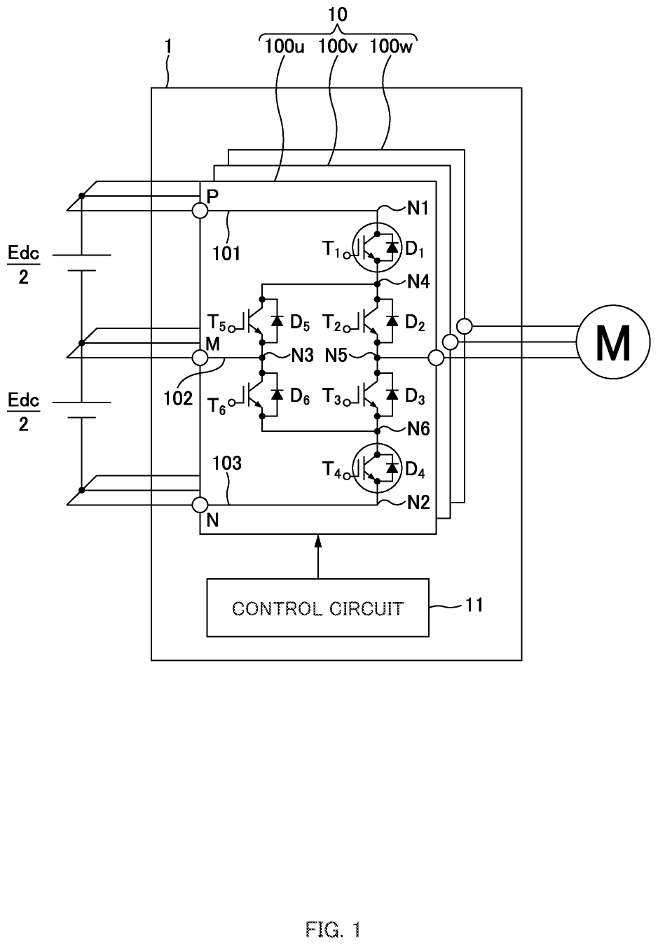

FIG. 1 is a diagram illustrating a power converter 1 according to this embodiment.

The power converter 1 includes a semiconductor module 10 and a control circuit 11.

### <Semiconductor Module>

An overview of the semiconductor module 10 according to this embodiment will be described with reference to FIG. 1. FIG. 1 is a diagram showing a configuration example of the semiconductor module 10. The semiconductor module 10 according to this embodiment is a module for generating an alternating-current (AC) voltage from a direct-current (DC) voltage and controlling the rotation speed of a three-phase motor M.

The semiconductor module 10 includes a U-phase converter circuit 100u, a V-phase converter circuit 100v, and a W-phase converter circuit 100w, which are coupled in parallel with each other. Since the U-phase converter circuit 100u, the V-phase converter circuit 100v, and the W-phase converter circuit 100w all have the same configuration, the configuration of the U-phase converter circuit 100u will be described below.

The U-phase converter circuit 100u of the semiconductor module 10 includes a plurality of parallel connection structures of insulated gate bipolar transistors (IGBTs, hereinafter simply referred to as “switching devices”) and diode devices. The “switching device” corresponds to the “IGBT”.

In this embodiment, the U-phase converter circuit 100u includes a first power supply line 101, a second power supply line 102, a third power supply line 103, six first to sixth switching devices (T1 to T6), and six first to sixth diode devices (D1 to D6). The i-th switching device T1 is coupled in parallel with the i-th diode device Di (i=1 to 6).

More specifically, the U-phase converter circuit 100u has six parallel connection structures. A parallel connection structure of the i-th switching device T1 and the i-th diode device Di is referred to as an “i-th parallel connection structure” (i=1 to 6). The converter circuit 100u according to this embodiment will be described in detail below.

### [Converter Circuit]

The converter circuit 100u according to this embodiment is a circuit that outputs a U-phase AC voltage Vu from an input DC voltage, and includes a so-called active neutral point clamp (A-NPC) circuit. The converter circuit 100u outputs the AC voltage Vu from a positive side potential P (corresponding to a “first potential on the positive side”), a negative side potential N (corresponding to a “second potential on the negative side”), and a neutral point potential M (corresponding to a “third potential”). Here, the neutral point potential M is lower than the positive side potential P and higher than the negative side potential N.

In this example, the positive side potential P is Edc/2 [V], the negative side potential N is −Edc/2 [V], and the neutral point potential P is 0 [V].

The converter circuit 100u has a node N1, a node N2, and a node N3. The node N1 is a node to which the positive side potential P is applied through the first power supply line 101. The node N2 is a node to which the negative side potential N is applied through the third power supply line 103. The node N3 is a node to which the neutral point potential M is applied through the second power supply line 102.

Among the first to sixth parallel connection structures (parallel connection structures of the i-th switching device Ti and the i-th diode device Di (i=1 to 4)), the first to fourth parallel connection structures are coupled in series from the first to fourth in descending order of potential between the node N1 (corresponding to the “first node”) and the node N2 (corresponding to the “second node”).

To be more specific, the first switching device T1 has its collector coupled to the node N1.

The fourth switching device T4 has its emitter coupled to the node N2.

A node N4 is a node to which an emitter of the first switching device T1 and a collector of the second switching device T2 are coupled between the nodes N1 and N2. Likewise, a node N5 is a node to which an emitter of the second switching device T2 and a collector of the third switching device T3 are coupled. Likewise, a node N6 is a node to which an emitter of the third switching device T3 and a collector of the fourth switching device T4 are coupled.

The fifth and sixth switching devices (T5 and T6) are coupled in series with each other between the nodes N4 and N6. To be more specific, the fifth switching device T5 has its collector coupled to the node N4. The sixth switching device T6 has its emitter coupled to the node N6.

The collector of the fifth switching device T5 and the emitter of the sixth switching device T6 are coupled at the node N3.

### [Reverse Conducting IGBT]

In this embodiment, among the first to sixth parallel connection structures, the first parallel connection structure (parallel connection structure of the first switching device T1 and the first diode device D1) and the fourth parallel connection structure (parallel connection structure of the fourth switching device T4 and the fourth diode device D4) are reverse conducting IGBTs.

Therefore, the first switching device T1 and the fourth switching device T4 are provided on the same chips as the first diode device D1 and the fourth diode device D4, respectively.

On the other hand, among the first to sixth switching devices (T1 to T6), the second, third, fifth, and sixth switching devices (T2, T3, T5, and T6) are provided on separate chips from the second, third, fifth, and sixth diode devices (D2, D3, D5, and D6), respectively.

### <Control Circuit>

The control circuit 11 generates PWM control signals S1 to S6 for the first to sixth switching devices (T1 to T6). The control circuit 11 is configured to be switchable between control modes including at least a PWM1 control mode (to be described later), which is a PWM control method used in this embodiment, and a PWM2 control mode (to be described later) used in a second embodiment.

In this embodiment, an example where the control circuit 11 operates in the PWM1 control mode will be described. The PWM1 control mode will be described below.

### [PWM1 Control Mode]

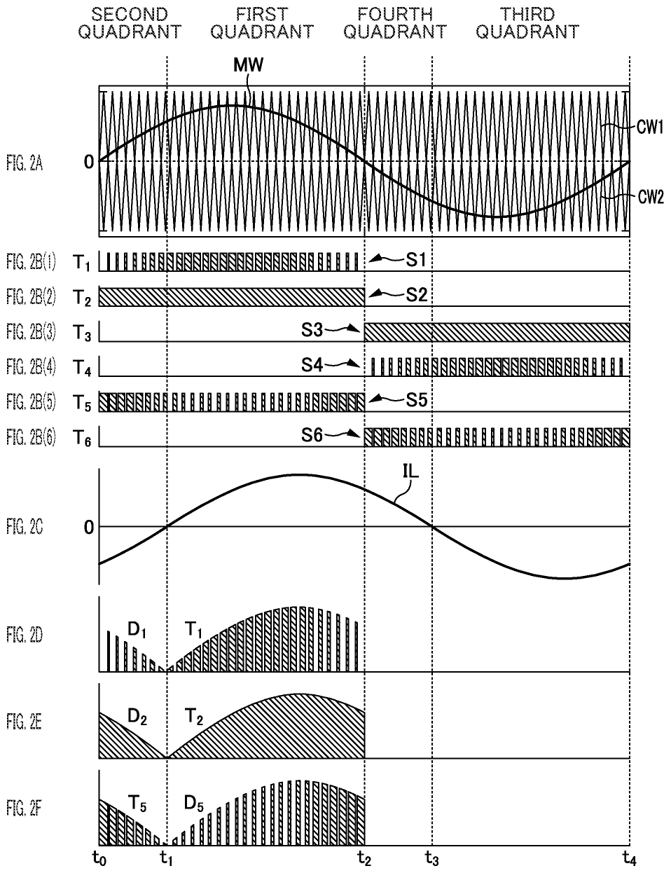

FIGS. 2A to 2F are diagrams illustrating the PWM1 control mode. FIGS. 2A to 2F are shown with time on the horizontal axis. Although described later in detail, the PWM1 control mode is a control mode for switching the first and fourth switching devices (T1 and T4) with a cycle shorter than that of the AC voltage Vu outputted by the converter circuit 100u.

FIG. 2A shows a modulated wave MW and two carrier waves CW1 and CW2 used in this embodiment. In this embodiment, the modulated wave MW is a sine wave centered at zero level. The carrier wave CW1 is a triangular wave always above zero level, while the carrier wave CW2 is a triangular wave always below zero level. The modulated wave MW and the two carrier waves CW1 and CW2 are signals generated inside the control circuit 11.

FIG. 2B shows control signals (S1 to S6) for the first to sixth switching devices (T1 to T6), which are generated based on the modulated wave MW and/or the carrier waves (CW1 and CW2) in FIG. 2A. FIG. 2B(1) to FIG. 2B(6) show the control signals (S1 to S6) for the first to sixth switching devices (T1 to T6), respectively.

The control signal S1 for the first switching device T1 shown in FIG. 2B(1) goes high when the carrier wave CW1 is lower than the modulated wave MW, and goes low when the carrier wave CW1 is higher than the modulated wave MW.

The control signal S2 for the second switching device T2 shown in FIG. 2B(2) goes high when the modulated wave MW is positive, and goes low when the modulated wave MW is negative.

The control signal S3 for the third switching device T3 shown in FIG. 2B(3) goes low when the modulated wave MW is positive, and goes high when the modulated wave MW is negative.

The control signal S4 for the fourth switching device T4 shown in FIG. 2B(4) goes low when the carrier wave CW2 is lower than the modulated wave MW, and goes high when the carrier wave CW2 is higher than the modulated wave MW.

The control signal S5 for the fifth switching device T5 shown in FIG. 2B(5) takes a value opposite to that of the control signal S1 for the first switching device T1 when the modulated wave MW is positive, and goes low when the modulated wave MW is negative.

The control signal S6 for the sixth switching device T6 shown in FIG. 2B(6) takes a value opposite to that of the control signal S4 for the fourth switching device T4 when the modulated wave MW is negative, and goes low when the modulated wave MW is positive.

FIG. 2C shows a load current IL. The load current IL is a current flowing through the three-phase motor M. FIG. 2D shows a current flowing through the first switching device T1 and the first diode device D1. FIG. 2E shows a current flowing through the second switching device T2 and the second diode device D2. FIG. 2F shows a current flowing through the fifth switching device T5 and the fifth diode device D5.

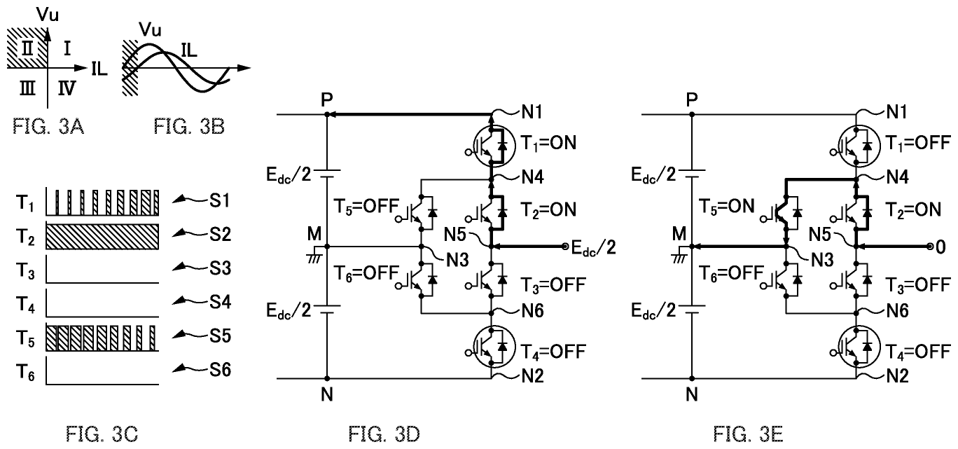

As illustrated in FIGS. 2A to 2F, the PWM1 control mode is divided into first to fourth quadrants. Hereinafter, operations of the converter circuit 100u in the respective quadrants will be described in detail in chronological order with reference to FIGS. 3A to 6E.

### Second Quadrant

FIGS. 3A to 3E are diagrams illustrating the second quadrant from time t0 to t1 in FIGS. 2A to 2F. FIG. 3A shows a relationship between the AC voltage Vu and the load current IL in the second quadrant (II in FIG. 3A). Here, the AC voltage Vu is a fundamental wave component of the AC voltage applied to the three-phase motor M by the converter circuit 100u. In FIG. 3B, a chronological period corresponding to the second quadrant is indicated by hatching.

The second quadrant is a period in which the AC voltage Vu is positive and the load current IL is negative (FIGS. 3A and 3B).

FIG. 3C shows the control signals (S1 to S6) for the first to sixth switching devices (T1 to T6). FIGS. 3D and 3E show switching states indicating whether the first to sixth switching devices (T1 to T6) are on or off, respectively, as well as the path of the current flowing through the converter circuit 100u.

As shown in FIGS. 3D and 3E, the positive side potential P is always applied to the node N1, the negative side potential N is always applied to the node N2, and the neutral point potential M is always applied to the node N3.

The second quadrant is a period in which the first switching device T1 is switched with a cycle shorter than that of the AC voltage Vu outputted by the converter circuit 100u, and is also a period in which the load current IL is negative.

In the second quadrant, the switching state of the second switching device T2 is always on as shown in FIG. 3C. Also, in the second quadrant, the switching states of the third, fourth, and sixth switching devices (T3, T4, and T6) are always off. Further, in the second quadrant, the switching state of the fifth switching device T5 is opposite to that of the first switching device T1.

FIG. 3D shows a case where the first switching device T1 is on. FIG. 3E shows a case where the first switching device T1 is off.

As shown in FIG. 3D, when the first switching device T1 is on, the positive side potential P (Edc/2 [V] in this example) is outputted to the node N5. Also, in this case, the load current IL flows in the direction from the node N5 to the node N1 via the second diode device D2 and the first diode device D1 (thick line).

Here, voltage drops due to forward currents flowing through the first to sixth diode devices (D1 to D6) are ignored. The same applies to the following description.

When the first switching device T1 is off, the neutral point potential M (0 [V] in this example) is outputted to the node N5 (FIG. 3E). Also, in this case, the load current IL flows in the direction from the node N5 to the node N3 via the second diode device D2 and the fifth switching device T5 (thick line).

### First Quadrant

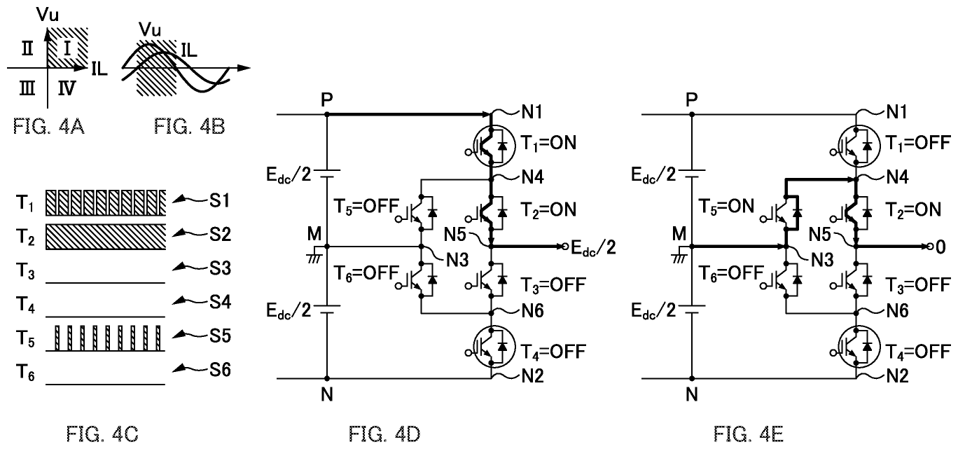

FIGS. 4A to 4E are diagrams illustrating the first quadrant from time t1 to t2 in FIGS. 2A to 2F. FIGS. 4A to 4E show the same items as those in FIGS. 3A to 3E. The first quadrant is a period in which the AC voltage Vu is positive and the load current IL is positive.

The first quadrant is the same as the second quadrant in the switching states of the first to sixth switching devices (T1 to T6) (FIG. 4C), but is different therefrom in that the load current IL is positive (FIGS. 4A and 4B).

When the first switching device T1 is on, the positive side potential P (Edc/2 [V] in this example) is outputted to the node N5 as shown in FIG. 4D. Also, in this case, the load current IL flows in the direction from the node N1 to the node N5 via the first switching device T1 and the second switching device T2 (thick line).

On the other hand, when the first switching device T1 is off, the neutral point potential M (0 [V] in this example) is outputted to the node N5 as shown in FIG. 4E. Also, in this case, the load current IL flows from the node N3 to the node N5 via the fifth switching device T5 and the second switching device T2 (thick line).

### Fourth Quadrant

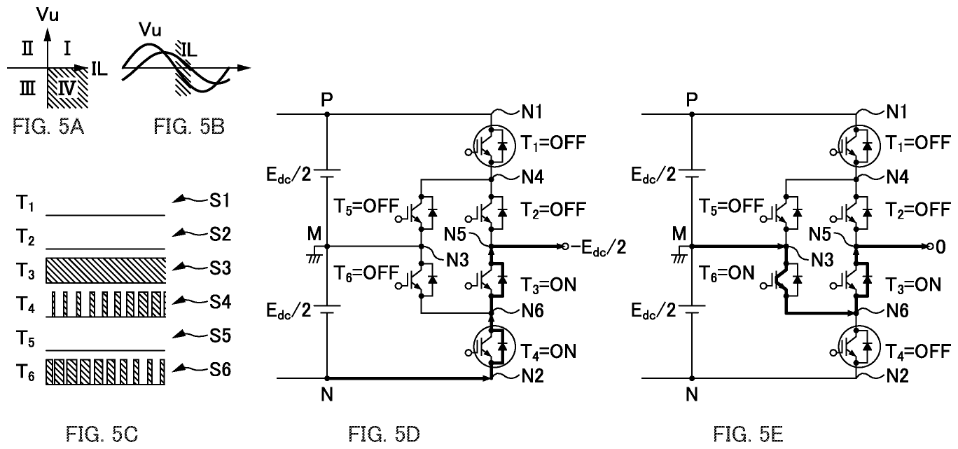

FIGS. 5A to 5E are diagrams illustrating the fourth quadrant from time t2 to t3 in FIGS. 2A to 2F. FIGS. 5A to 5E show the same items as those in FIGS. 3A to 3E. The fourth quadrant is a period in which the AC voltage Vu is negative and the load current IL is positive.

The fourth quadrant is a period in which the fourth switching device T4 is switched with a cycle shorter than that of the AC voltage Vu outputted by the converter circuit 100u, and is also a period in which the load current IL is positive.

In the fourth quadrant, the switching state of the third switching device T3 is always on as shown in FIG. 5C. Also, in the fourth quadrant, the switching states of the first, second, and fifth switching devices (T1, T2, and T5) are always off. Further, in the fourth quadrant, the switching state of the sixth switching device T6 is opposite to that of the fourth switching device T4.

FIG. 5D shows a case where the fourth switching device T4 is on. FIG. 5E shows a case where the fourth switching device T4 is off.

When the fourth switching device T4 is on, the negative side potential N (−Edc/2 [V] in this example) is outputted to the node N5 as shown in FIG. 5D. Also, in this case, the load current IL flows in the direction from the node N2 to the node N5 via the fourth diode device D4 and the third diode device D3 (thick line).

On the other hand, when the fourth switching device T4 is off, the neutral point potential M (0 [V] in this example) is outputted to the node N5 as shown in FIG. 5E. Also, in this case, the load current IL flows in the direction from the node N6 to the node N5 via the sixth switching device T6 and the third switching device T3 (thick line).

### Third Quadrant

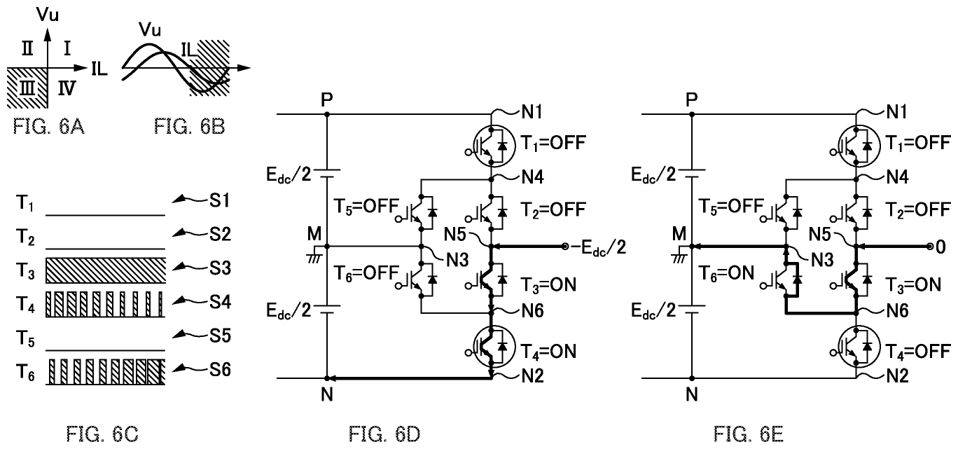

FIGS. 6A to 6E are diagrams illustrating the third quadrant from time t3 to t4 in FIGS. 2A to 2F. FIGS. 6A to 6E show the same items as those in FIGS. 3A to 3E. The third quadrant is a period in which the AC voltage Vu is negative and the load current IL is negative (FIGS. 6A and 6B).

The third quadrant is the same as the fourth quadrant in the switching states of the first to sixth switching devices (T1 to T6) but is different therefrom in that the load current IL is negative (FIGS. 6A and 6B).

When the fourth switching device T4 is on, the negative side potential N (−Edc/2 [V] in this example) is outputted to the node N5 as shown in FIG. 6D. Also, in this case, the load current IL flows in the direction from the node N5 to the node N2 via the third switching device T3 and the fourth switching device T4 (thick line).

On the other hand, when the fourth switching device T4 is off, the neutral point potential M (0 [V] in this example) is outputted to the node N5 as shown in FIG. 6E. Also, in this case, the load current IL flows in the direction from the node N5 to the node N3 via the third switching device T3 and the sixth switching device T6 (thick line).

### Summary of PWM1 Control Mode

It can be said that the PWM1 control mode described above is a control mode in which the first and fourth switching devices (T1 and T4) among the first to fourth switching devices (T1 to T4) are switched with a cycle shorter than that of the AC voltage Vu. It can also be said that the PWM1 control mode is a control mode in which the second and third switching devices (T2 and T3) are switched with a cycle half that of the AC voltage Vu.

In such a case, from the following observations, the first switching device T1, the fourth switching device T4, the first diode device D1, and the fourth diode device D4 are considered to generate more heat than the second switching device T2, the third switching device T3, the second diode device D2, and the third diode device D3.

The first to fourth switching devices (T1 to T4) and the first to fourth diode devices (D1 to D4) coupled in series are considered to contribute more to the heat generation in the semiconductor module 10 than the fifth and sixth switching devices (T5 and T6) or the fifth and sixth diode devices (D5 and D6), since the average value of the current flowing through the first to fourth switching devices and the first to fourth diode devices is equal to or greater than that of the current flowing through the fifth and sixth switching devices or the fifth and sixth diode devices.

Therefore, the following observations are made only on eight devices including the first to fourth switching devices (T1 to T4) and the first to fourth diode devices (D1 to D4) among the twelve devices including the first to sixth switching devices (T1 to T6) and the first to sixth diode devices (D1 to D6).

First, as can be seen from FIGS. 2E and 3A to 3E, in the second quadrant, the first diode device D1 repeats passing and blocking of the load current IL as the first switching device T1 is switched. The other devices either do not pass the load current IL or repeat passing and blocking of the load current IL with a cycle half that of the modulated wave MW.

More specifically, in the second quadrant, the first diode device D1 most frequently repeats passing and blocking of the load current IL. Therefore, in the second quadrant, the first diode device D1 is most likely to generate heat, leading to a concern about a highest temperature rise.

As can be seen from FIGS. 2E and 4A to 4E, in the first quadrant, the first switching device T1 repeats passing and blocking of the current as the first switching device T1 is switched. The other devices either do not pass the load current IL or repeat passing and blocking of the load current IL with a cycle half that of the modulated wave MW.

More specifically, in the first quadrant, the first switching device T1 most frequently repeats passing and blocking of the load current IL. Therefore, in the first quadrant, the first switching device T1 is most likely to generate heat, leading to a concern about a highest temperature rise.

Likewise, in the fourth quadrant, the fourth diode device D4 most frequently repeats passing and blocking of the load current IL. Therefore, in the fourth quadrant, the fourth diode device D4 is most likely to generate heat, leading to a concern about a highest temperature rise.

In the third quadrant, the fourth switching device T4 most frequently repeats passing and blocking of the load current IL. Therefore, in the third quadrant, the fourth switching device T4 is most likely to generate heat, leading to a concern about a highest temperature rise.

### General Power Converter

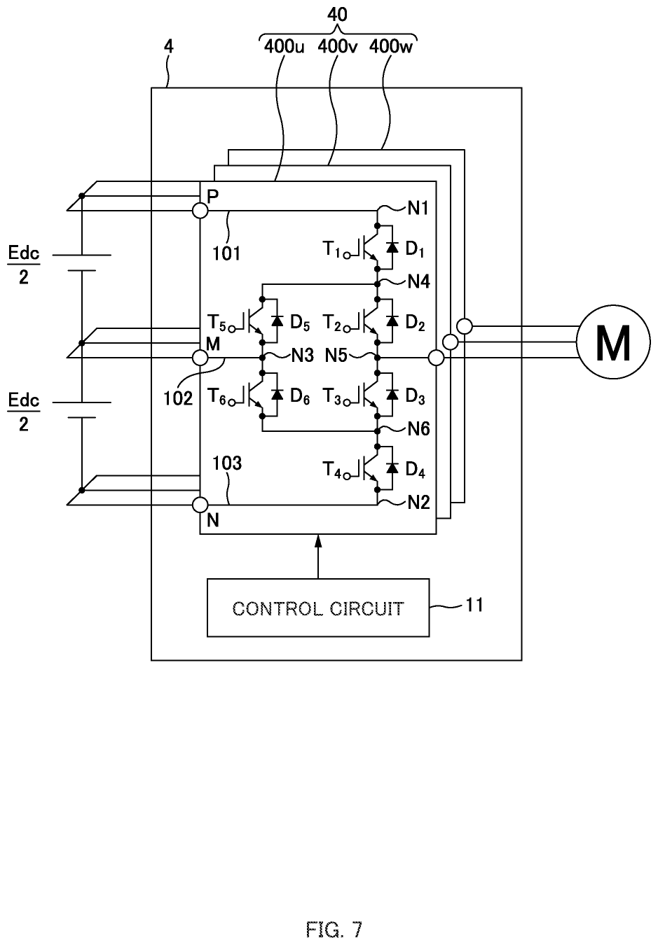

Prior to making observations about a case where PWM1 control is applied to the power converter 1 according to this embodiment, a general power converter 4 will be described for comparison. FIG. 7 is a diagram illustrating the general power converter 4.

The general power converter 4 is different from the power converter 1 according to this embodiment in having the first to sixth switching devices (T1 to T6) provided on separate chips from the first to sixth diode devices (D1 to D6), respectively. In other words, reverse conducting IGBTs are not adopted for the first to sixth switching devices (T1 to T6).

### Application of PWM1 Control to Semiconductor Module According to Present Embodiment

As described above, in the semiconductor module 10 according to this embodiment, the first and fourth switching devices T1 and T4 are reverse conducting IGBTs.

More specifically, the first switching device T1 is a reverse conducting IGBT including the first diode device D1, and the first switching device T1 and the first diode device D1 are provided on the same chip. Likewise, the fourth switching device T4 is a reverse conducting IGBT including the fourth diode device D4, and the fourth switching device T4 and the fourth diode device D4 are provided on the same chip.

With the configuration of the semiconductor module 10 according to this embodiment, in the second quadrant, heat generated by passing and blocking of the current in the first diode device D1 is considered to diffuse into the first switching device T1, thus suppressing a temperature rise in the first diode device D1.

However, with a configuration of a general semiconductor module 40, in the second quadrant, heat generated by passing and blocking of the current in the first diode device D1 is less likely to diffuse as compared to this embodiment, since a substrate having chips mounted thereon has to be provided in order for the heat to diffuse to the first switching device T1 provided on a separate chip. Therefore, the general semiconductor module 40 is considered to have a larger temperature rise in the first diode device D1 as compared to this embodiment.

With the configuration of the semiconductor module 10 according to this embodiment, in the first quadrant, the heat generated by passing and blocking of the current in the first switching device T1 is considered to diffuse into the first diode device D1, thus suppressing a temperature rise in the first switching device T1.

However, with the configuration of the general semiconductor module 40, in the first quadrant, heat generated by passing and blocking of the current in the first switching device T1 is less likely to diffuse into the first diode device D1 provided on a separate chip. Therefore, the general semiconductor module 40 is considered to have a larger temperature rise in the first switching device T1 as compared to this embodiment.

With the configuration of the semiconductor module 10 according to this embodiment, in the fourth quadrant, the heat generated by passing and blocking of the current in the fourth diode device D4 is considered to diffuse into the fourth switching device T4, thus suppressing a temperature rise in the fourth diode device D4.

However, with the configuration of the general semiconductor module 40, in the fourth quadrant, heat generated by passing and blocking of the current in the fourth diode device D4 is less likely to diffuse into the fourth switching device T4 provided on a separate chip. Therefore, the general semiconductor module 40 is considered to have a larger temperature rise in the fourth diode device D4 as compared to this embodiment.

With the configuration of the semiconductor module 10 according to this embodiment, in the third quadrant, the heat generated by passing and blocking of the current in the fourth switching device T4 is considered to diffuse into the fourth diode device D4, thus suppressing a temperature rise in the fourth switching device T4.

However, with the configuration of the general semiconductor module 40, in the third quadrant, heat generated by passing and blocking of the current in the fourth switching device T4 is less likely to diffuse into the fourth diode device D4 provided on a separate chip. Therefore, the general semiconductor module 40 is considered to have a larger temperature rise in the fourth switching device T4 as compared to this embodiment.

### <<Thermal Simulation>>

In order to examine a temperature rise due to heat generated in each of the first to sixth switching devices (T1 to T6) and the first to sixth diode devices (D1 to D6), thermal simulations are conducted on the semiconductor module according to this embodiment and on the general semiconductor module 40 when controlled in the PWM1 control mode.

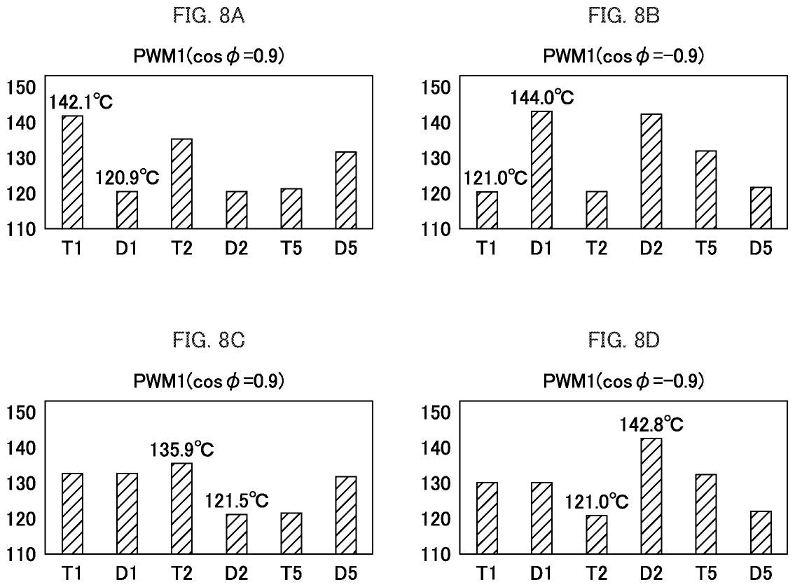

FIGS. 8A to 8D are diagrams illustrating thermal simulation results of the semiconductor module 10. FIGS. 8A to 8D show the results of temperature rises in the respective devices.

Here, only the results of the first switching device T1, the first diode device D1, the second switching device T2, the second diode device D2, the fifth switching device T5, and the fifth diode device D5 are shown.

The results of the fourth switching device T4, the fourth diode device D4, the third switching device T3, the third diode device D3, the sixth switching device T6, and the sixth diode device D6 are the same as those of the first switching device T1, the first diode device D1, the second switching device T2, the second diode device D2, the fifth switching device T5, and the fifth diode device D5, respectively, and thus illustration thereof is omitted.

FIGS. 8A and 8B show the results on the general semiconductor module 40. FIG. 8A shows the results with a power factor of 0.9, while FIG. 8B shows the results with a power factor of −0.9. FIGS. 8C and 8D show the results on the semiconductor module 10 according to this embodiment. FIG. 8C shows the results with a power factor of 0.9, while FIG. 8D shows the results with a power factor of −0.9.

The results (FIGS. 8A and 8C) of the general semiconductor module 40 and the semiconductor module 10 according to this embodiment are compared when the power factor is 0.9.

In the general semiconductor module 40, the first switching device T1 has the highest temperature of 142.1 degrees. The first diode device D1 has the lowest temperature of 120.9 degrees. Therefore, the maximum temperature difference between the devices is 21.2 degrees.

On the other hand, in the semiconductor module 10 according to this embodiment, the second switching device T2 has the highest temperature of 135.9 degrees. The second diode device D2 has the lowest temperature of 121.5 degrees. Therefore, the maximum temperature difference between the devices is 14.4 degrees.

These differences are due to the fact that, in the semiconductor module 10 according to this embodiment, the heat generated by passing and blocking of the current in the first switching device T1 diffuses into the first diode device D1, thus suppressing a temperature rise in the first switching device T1 and promoting a temperature rise in the first diode device D1 as compared to the general semiconductor module 40.

Next, the results (FIGS. 8B and 8D) of the general semiconductor module 40 and the semiconductor module 10 according to this embodiment are compared when the power factor is −0.9.

In the general semiconductor module 40, the first diode device D1 has the highest temperature of 144.0 degrees. The first switching device T1 has the lowest temperature of 121.0 degrees. Therefore, the maximum temperature difference between the devices is 23.0 degrees.

On the other hand, in the semiconductor module 10 according to this embodiment, the second diode device D2 has the highest temperature of 142.8 degrees. The second switching device T2 has the lowest temperature of 121.0 degrees. Therefore, the maximum temperature difference between the devices is 21.8 degrees.

These differences are due to the fact that, in the semiconductor module 10 according to this embodiment, the heat generated by passing and blocking of the current in the first diode device D1 diffuses into the first switching device T1, thus suppressing a temperature rise in the first diode device D1 and promoting a temperature rise in the first switching device T1 as compared to the general semiconductor module 40.

From the thermal simulation results described above, it can be seen that the semiconductor module 10 according to this embodiment can suppress a temperature rise in the device with the highest temperature as compared to the general semiconductor module 40.

### Summary of First Embodiment

The semiconductor module 10 according to this embodiment is different from the general semiconductor module 40 in that the first and fourth parallel connection structures are reverse conducting IGBTs, among the i-th parallel connection structures (parallel connection structures of the i-th switching devices and the i-th diode devices).

Such a configuration makes it possible to suppress a temperature rise in a device with a highest temperature in the PWM1 control mode from the thermal simulation result.

The first and fourth switching devices (T1 and T4) are switching devices that are switched with a cycle shorter than that of the AC voltage Vu in the PWM1 control mode.

More generally, among the first to fourth parallel connection structures, the parallel connection structure including a switching device that is switched with a cycle shorter than that of the AC voltage Vu may be a reverse conducting IGBT. Such a configuration makes it possible to suppress a temperature rise in the device with the highest temperature.

At least one of the first to sixth parallel connection structures may be a reverse conducting IGBT. Such a configuration makes it possible to suppress a temperature rise in the reverse conducting IGBT as a whole due to heat generated by one of the switching device and the diode device included in the reverse conducting IGBT.

### Second Embodiment

### <<Power Converter>>

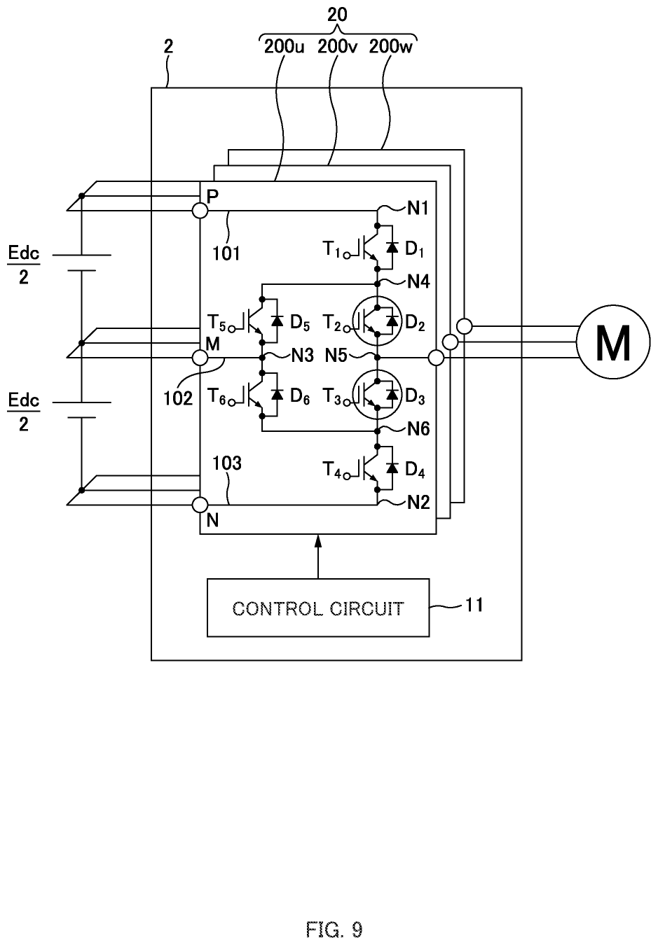

FIG. 9 is a diagram illustrating a power converter 2 according to this embodiment. The power converter 2 according to this embodiment is different from the first embodiment in a configuration of a converter circuit 200u. To be more specific, switching devices included in reverse conducting IGBTs and diode devices are different. The power converter 2 according to this embodiment is driven in a PWM2 control mode.

### [Reverse Conducting IGBT]

In this embodiment, among the first to sixth switching devices (T1 to T6), the second and third switching devices T2 and T3 are reverse conducting IGBTs. That is, the second and third switching devices (T2 and T3) are reverse conducting IGBTs including second and third diode devices (D2 and D3) coupled in parallel with each other.

Therefore, the second and third switching devices T2 and T3 are provided on the same chips as the second and third diode devices D2 and D3, respectively.

On the other hand, among the first to sixth switching devices (T1 to T6), the first, fourth, fifth, and sixth switching devices (T1, T4, T5, and T6) are provided on separate chips from the first, fourth, fifth, and sixth diode devices (D1, D4, D5, and D6), respectively.

### [PWM2 Control Mode]

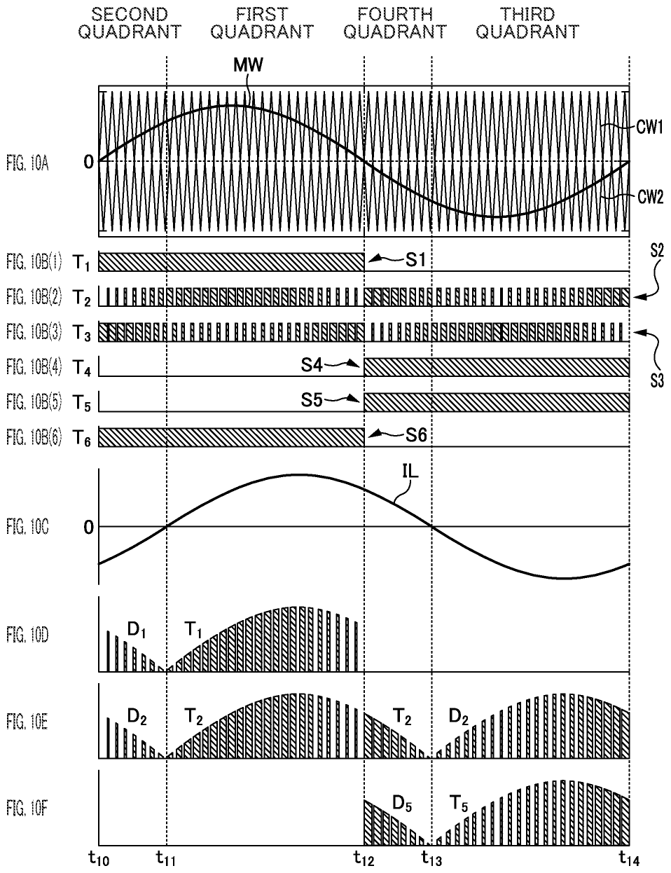

FIGS. 10A to 10F are diagrams illustrating the PWM2 control mode. FIGS. 10A to 10F are shown with time on the horizontal axis. Although described later in detail, the PWM2 control mode is a control mode for switching the second and third switching devices (T2 and T3) with a cycle shorter than that of the AC voltage Vu outputted by the converter circuit 200u.

FIG. 10A shows a modulated wave MW and two carrier waves (CW1 and CW2) used in this embodiment. These are the same as those in the first embodiment (FIG. 2A).

FIG. 10B shows control signals (S1 to S6) for the first to sixth switching devices (T1 to T6), which are generated based on the modulated wave MW and/or the carrier waves (CW1 and CW2) in FIG. 10A. FIG. 10B(1) to FIG. 10B(6) show the control signals (S1 to S6) for the first to sixth switching devices (T1 to T6), respectively.

The control signal S1 for the first switching device T1 shown in FIG. 10B(1) goes high when the modulated wave MW is positive, and becomes zero when the modulated wave MW is negative.

The control signal S2 for the second switching device T2 shown in FIG. 10B(2) goes high when the modulated wave MW is positive and higher than the carrier wave CW1, and goes high when the modulated wave MW is negative and lower than the carrier wave CW2.

The control signal S3 for the third switching device T3 shown in FIG. 10B(3) goes high when the modulated wave MW is positive and lower than the carrier wave CW1, and goes high when the modulated wave MW is negative and higher than the carrier wave CW2.

The control signal S4 for the fourth switching device T4 shown in FIG. 10B(4) becomes zero when the modulated wave MW is positive, and goes high when the modulated wave MW is negative.

The control signal S5 for the fifth switching device T5 shown in FIG. 10B(5) becomes zero when the modulated wave MW is positive, and goes high when the modulated wave MW is negative.

The control signal S6 for the sixth switching device T6 shown in FIG. 10B(6) goes high when the modulated wave MW is positive, and becomes zero when the modulated wave MW is negative.

FIG. 10C shows the load current IL as in the first embodiment (FIGS. 2A to 2F). FIG. 10D to FIG. 10F show the same currents as those in the first embodiment (FIGS. 2A to 2F).

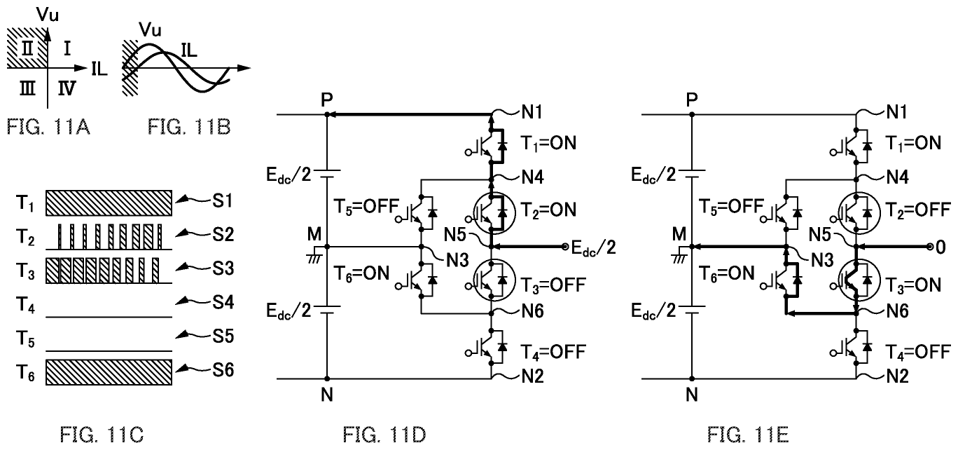

As illustrated in FIGS. 10A to 10F, the PWM2 control mode is divided into first to fourth quadrants. Hereinafter, operations of the converter circuit 200u in the respective quadrants will be described in detail in chronological order with reference to FIGS. 11A to 16. FIGS. 11A to 16 show the same items as those shown in FIGS. 3A to 8D described in the first embodiment, but differ in that PWM2 control is applied to the semiconductor module 20.

### Second Quadrant

FIGS. 11A to 11E are diagrams illustrating the second quadrant from time t10 to t11 in FIGS. 10A to 10F. The second quadrant is a period in which the AC voltage Vu is positive and the load current IL is negative (FIGS. 11A and 11B).

The second quadrant is a period in which the second switching device T2 is switched with a cycle shorter than that of the AC voltage Vu outputted by the converter circuit 200u, and is a period in which the load current IL is negative. Also, in the second quadrant, the switching state of the third switching device T3 is opposite to that of the second switching device T2.

In the second quadrant, the switching state of the first switching device T1 is always on. Also, in the second quadrant, the switching states of the fourth and fifth switching devices (T4 and T5) are always off.

FIG. 11D shows a case where the second switching device T2 is on. FIG. 11E shows a case where the second switching device T2 is off.

When the second switching device T1 is on, the positive side potential P (Edc/2 [V] in this example) is outputted to the node N5 as shown in FIG. 11D. Also, in this case, the load current IL flows in the direction from the node N5 to the node N1 via the second diode device D2 and the first diode device D1 (thick line).

When the first switching device T1 is off, the neutral point potential M (0 [V] in this example) is outputted to the node N5 as shown in FIG. 11E. Also, in this case, the load current IL flows in the direction from the node N5 to the node N3 via the third switching device T3 and the sixth switching device T6 (thick line).

### First Quadrant

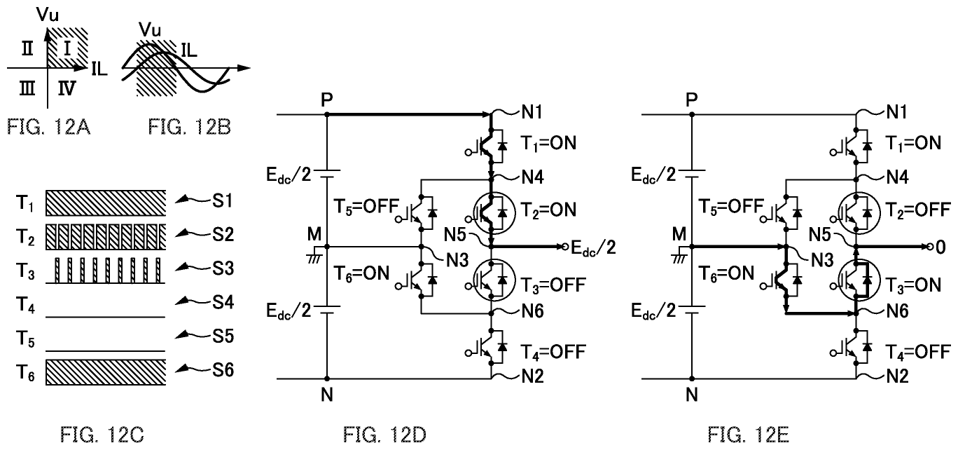

FIGS. 12A to 12E are diagrams illustrating the first quadrant from time t11 to t12 in FIGS. 10A to 10F. FIGS. 12A to 12E show the same items as those in FIGS. 11A to 11E. The first quadrant is a period in which the AC voltage Vu is positive and the load current IL is positive.

The first quadrant is the same as the second quadrant in the switching states of the first to sixth switching devices (T1 to T6) (FIG. 12C), but is different therefrom in that the load current IL is positive (FIGS. 12A and 12B).

When the second switching device T2 is on, the positive side potential P (Edc/2 [V] in this example) is outputted to the node N5 as shown in FIG. 12D. Also, in this case, the load current IL flows in the direction from the node N1 to the node N5 via the first switching device T1 and the second switching device T2 (thick line).

On the other hand, when the second switching device T2 is off, the neutral point potential M (0 [V] in this example) is outputted to the node N5 as shown in FIG. 12E. Also, in this case, the load current IL flows in the direction from the node N3 to the node N5 via the sixth switching device T6 and the third diode device D3 (thick line).

### Fourth Quadrant

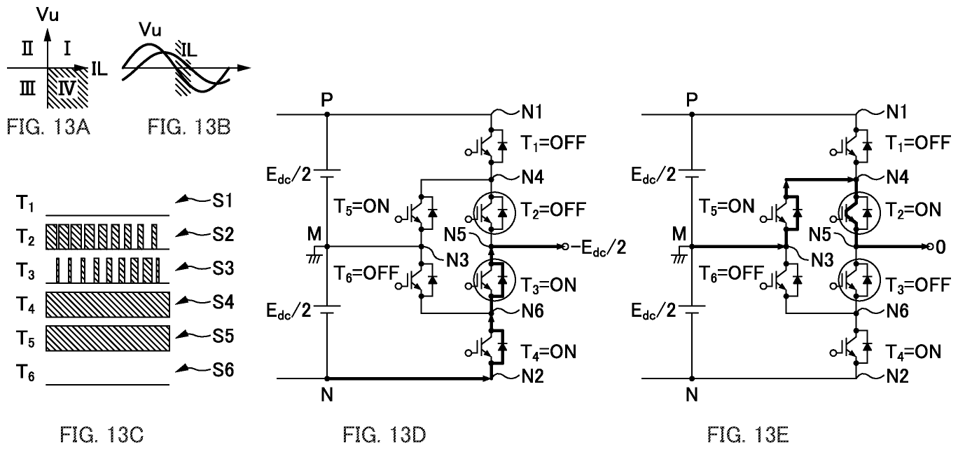

FIGS. 13A to 13E are diagrams illustrating the fourth quadrant from time t12 to t13 in FIGS. 10A to 10F. FIGS. 13A to 13E show the same items as those in FIGS. 11A to 11E. The fourth quadrant is a period in which the AC voltage Vu is negative and the load current IL is positive.

The fourth quadrant is a period in which the second switching device T2 is switched with a cycle shorter than that of the AC voltage Vu outputted by the converter circuit 200u, and is a period in which the load current IL is positive.

In the fourth quadrant, the switching states of the first and sixth switching devices (T1 and T6) are always off as shown in FIG. 13C. Also, in the fourth quadrant, the switching states of the fourth and fifth switching devices (T4 and T5) are always on.

FIG. 13D shows a case where the third switching device T3 is on. FIG. 13E shows a case where the third switching device T3 is off.

When the third switching device T3 is on, the negative side potential N (−Edc/2 [V] in this example) is outputted to the node N5 as shown in FIG. 13D. Also, in this case, the load current IL flows in the direction from the node N2 to the node N5 via the fourth diode device D4 and the third diode device D3 (thick line).

When the third switching device T3 is off, the neutral point potential M (0 [V] in this example) is outputted to the node N5 as shown in FIG. 13E. Also, in this case, the load current IL flows in the direction from the node N3 to the node N5 via the fifth diode device D5 and the second switching device T2 (thick line).

### Third Quadrant

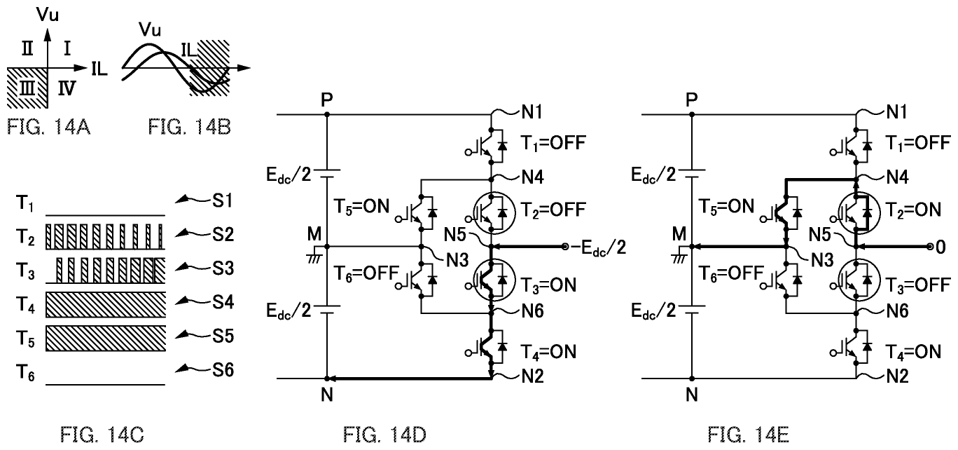

FIGS. 14A to 14E are diagrams illustrating the third quadrant from time t13 to t14 in FIGS. 10A to 10F. FIGS. 14A to 14E show the same items as those in FIGS. 11A to 11E. The third quadrant is a period in which the AC voltage Vu is negative and the load current IL is negative.

The third quadrant is the same as the fourth quadrant in the switching states of the first to sixth switching devices (T1 to T6), but is different therefrom in that the load current IL is negative (FIGS. 14A and 14B).

When the third switching device T3 is on, the negative side potential N (−Edc/2 [V] in this example) is outputted to the node N5 as shown in FIG. 14D. Also, in this case, the load current IL flows in the direction from the node N5 to the node N2 via the third switching device T3 and the fourth switching device T4 (thick line).

On the other hand, when the fourth switching device T4 is off, the neutral point potential M (0 [V] in this example) is outputted to the node N5 as shown in FIG. 14E. Also, in this case, the load current IL flows in the direction from the node N5 to the node N3 via the second diode device D2 and the fifth switching device T5 (thick line).

### Summary of PWM2 Control Mode

It can be said that the PWM2 control mode described above is a control mode in which the second and third switching devices (T2 and T3) among the first to fourth switching devices (T1 to T4) are switched with a cycle shorter than that of the AC voltage Vu. It can also be said that the PWM2 control mode is a control mode in which the first and fourth switching devices (T1 and T4) are switched with a cycle half that of the AC voltage Vu.

In such a case, from the following observations, the second switching device T2, the third switching device T3, the second diode device D2, and the third diode device D3 are considered to generate more heat than the first switching device T1, the fourth switching device T4, the first diode device D1, and the fourth diode device D4.

The first to fourth switching devices (T1 to T4) and the first to fourth diode devices (D1 to D4) coupled in series are considered to contribute more to the heat generation in the semiconductor module 20 than the fifth and sixth switching devices (T5 and T6) or the fifth and sixth diode devices (D5 and D6), since the average value of the current flowing through the first to fourth switching devices and the first to fourth diode devices is equal to or greater than that of the current flowing through the fifth and sixth switching devices or the fifth and sixth diode devices.

Therefore, the following observations are made only on eight devices including the first to fourth switching devices (T1 to T4) and the first to fourth diode devices (D1 to D4) among the twelve devices including the first to sixth switching devices (T1 to T6) and the first to sixth diode devices (D1 to D6).

First, as can be seen from FIG. 10E, a period in which the second switching device T2 and the second diode device D2 repeat blocking of the load current IL is longer than that for the first switching device T1 and the first diode device D1.

To be more specific, the second switching device T2 repeats blocking of the load current IL in the first and fourth quadrants. The second diode device D2 repeats blocking of the load current IL in the second and third quadrants.

On the other hand, the first switching device T1 repeats blocking of the load current IL only in the first quadrant. The first diode device D1 repeats blocking of the load current IL only in the second quadrant.

Although not illustrated, a period in which the third switching device T3 and the third diode device D3 repeat blocking of the load current IL is longer than that for the fourth switching device T4 and the fourth diode device D4.

Therefore, in the first to fourth quadrants, the second switching device T2, the second diode device D2, the third switching device T3, and the third diode device D3 are particularly likely to generate heat, leading to a concern about a higher temperature rise compared to the other devices.

### Application of PWM2 Control to Semiconductor Module According to Embodiment

As described above, in the semiconductor module 20 according to this embodiment, the second and third switching devices T2 and T3 are reverse conducting IGBTs.

More specifically, the second switching device T2 is a reverse conducting IGBT including the second diode device D2, and the second switching device T2 and the second diode device D2 are provided on the same chip. Likewise, the third switching device T3 is a reverse conducting IGBT including the third diode device D3, and the third switching device T3 and the third diode device D3 are provided on the same chip.

With the configuration of the semiconductor module 20 according to this embodiment, in the second and third quadrants, heat generated by passing and blocking of the current in the second diode device D2 is considered to diffuse into the second switching device T2, thus suppressing a temperature rise in the second diode device D2.

However, with the configuration of the general semiconductor module 40, in the second and third quadrants, heat generated by passing and blocking of the current in the second diode device D2 is less likely to diffuse into the second switching device T2 provided on a separate chip. Therefore, the general semiconductor module 40 is considered to have a larger temperature rise in the second diode device D2 as compared to this embodiment.

With the configuration of the semiconductor module 20 according to this embodiment, in the first and fourth quadrants, the heat generated by passing and blocking of the current in the second switching device T2 is considered to diffuse into the second diode device D2, thus suppressing a temperature rise in the second switching device T2.

However, with the configuration of the general semiconductor module 40, in the first and fourth quadrants, heat generated by passing and blocking of the current in the second switching device T2 is less likely to diffuse into the second diode device D2 provided on a separate chip. Therefore, the general semiconductor module 40 is considered to have a larger temperature rise in the second switching device T2 as compared to this embodiment.

### <<Thermal Simulation>>

In order to examine a temperature rise due to heat generated in each of the first to sixth switching devices (T1 to T6) and the first to sixth diode devices (D1 to D6), thermal simulations are conducted on the semiconductor module according to this embodiment and on the general semiconductor module when controlled in the PWM2 control mode.

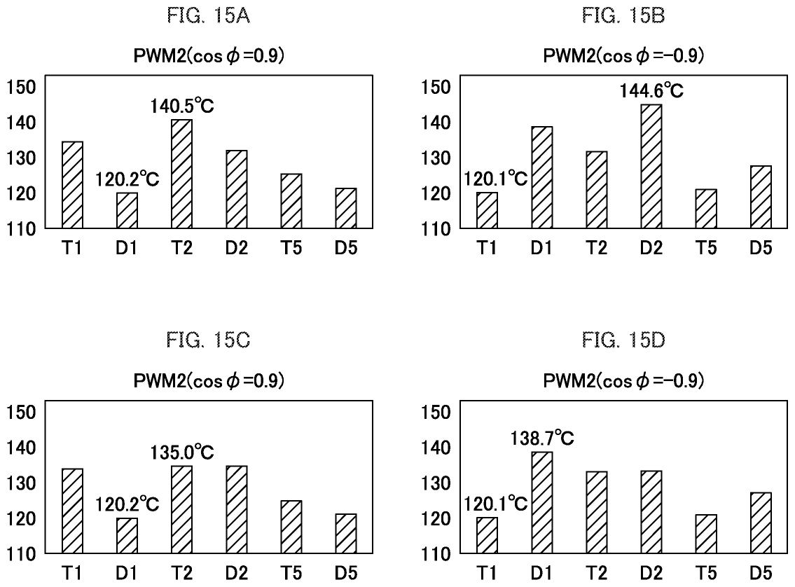

FIGS. 15A to 15D are diagrams illustrating thermal simulation results of the semiconductor module 20. FIGS. 15A to 15D show the results of temperature rises in the respective devices.

Here, only the results of the first switching device T1, the first diode device D1, the second switching device T2, the second diode device D2, the fifth switching device T5, and the fifth diode device D5 are shown.

The results of the fourth switching device T4, the fourth diode device D4, the third switching device T3, the third diode device D3, the sixth switching device T6, and the sixth diode device D6 are due to the same reason described in the first embodiment, and thus illustration thereof is omitted.

FIGS. 15A and 15B show the results on the general semiconductor module 40. FIG. 15A shows the results with a power factor of 0.9, while FIG. 15B shows the results with a power factor of −0.9. FIGS. 15C and 15D show the results on the semiconductor module 20 according to this embodiment. FIG. 15C shows the results with a power factor of 0.9, while FIG. 15D shows the results with a power factor of −0.9.

The results (FIGS. 15A and 15C) of the general semiconductor module 40 and the semiconductor module 20 according to this embodiment are compared when the power factor is 0.9.

In the general semiconductor module 40, the second switching device T2 has the highest temperature of 140.5 degrees. The first diode device D1 has the lowest temperature of 120.2 degrees. Therefore, the maximum temperature difference between the devices is 20.3 degrees.

On the other hand, in the semiconductor module 20 according to this embodiment, the second switching device T2 has the highest temperature of 135.0 degrees. The first diode device D1 has the lowest temperature of 120.2 degrees. Therefore, the maximum temperature difference between the devices is 14.8 degrees.

These differences are due to the fact that, in the semiconductor module 20 according to this embodiment, the heat generated by passing and blocking of the current in the second switching device T2 diffuses into the second diode device D2, thus suppressing a temperature rise in the second switching device T2 and promoting a temperature rise in the second diode device D2 as compared to the general semiconductor module 40. Next, the results (FIGS. 15B and 15D) of the general semiconductor module 40 and the semiconductor module 20 according to this embodiment are compared when the power factor is −0.9.

In the general semiconductor module 40, the second diode device D2 has the highest temperature of 144.6 degrees. The first switching device T1 has the lowest temperature of 120.1 degrees. Therefore, the maximum temperature difference between the devices is 24.4 degrees.

On the other hand, in the semiconductor module 20 according to this embodiment, the first diode device D1 has the highest temperature of 138.7 degrees. The first switching device T1 has the lowest temperature of 120.1 degrees. Therefore, the maximum temperature difference between the devices is 18.6 degrees.

These differences are due to the fact that, in the semiconductor module 20 according to this embodiment, the heat generated by passing and blocking of the current in the second diode device D2 diffuses into the second switching device T2, thus suppressing a temperature rise in the second diode device D2 and promoting a temperature rise in the second switching device T2 as compared to the general semiconductor module 40.

From the thermal simulation results described above, it can be seen that the semiconductor module 20 according to this embodiment can suppress a temperature rise in the device with the highest temperature as compared to the general semiconductor module 40.

### Summary of Second Embodiment

The semiconductor module 20 according to this embodiment is different from the general semiconductor module 40 in that the second and third parallel connection structures are reverse conducting IGBTs, among the i-th parallel connection structures (parallel connection structures of the i-th switching devices T1 and the i-th diode devices Di). Such a configuration makes it possible to suppress a temperature rise in a device with a highest temperature in the PWM2 control mode from the thermal simulation result.

### Third Embodiment

### <<Power Converter>>

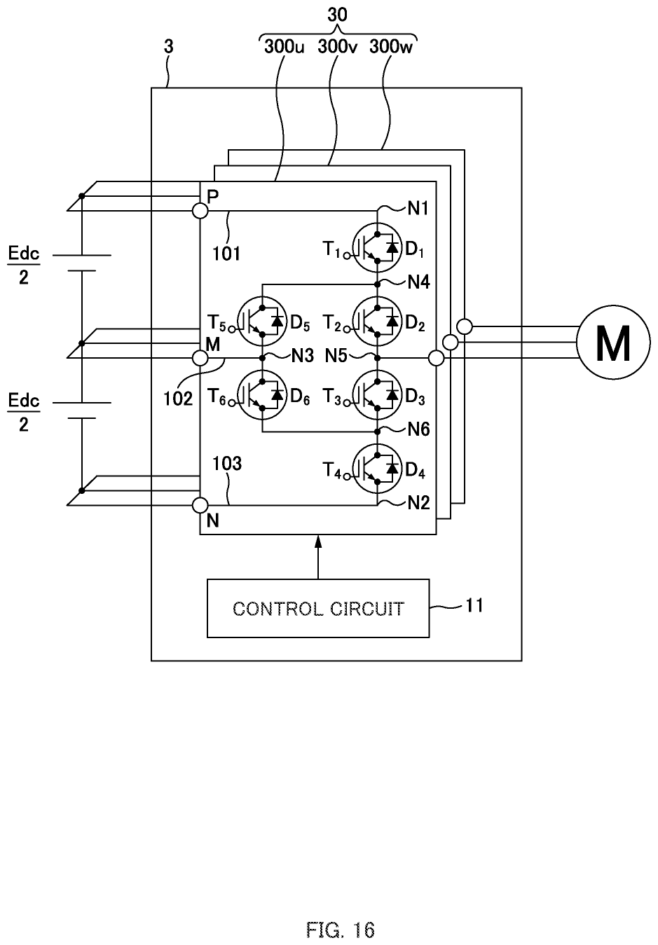

FIG. 16 is a diagram illustrating a power converter 3 according to this embodiment. The power converter 3 according to this embodiment is different from that of the first embodiment in a configuration of a converter circuit 300u. To be more specific, switching devices included in reverse conducting IGBTs and diode devices are different.

### [Reverse Conducting IGBT]

In this embodiment, first to sixth switching devices (T1 to T6) are all reverse conducting IGBTs. More specifically, it can be said that i-th parallel connection structures (parallel connection structures of i-th switching devices Ti and i-th diode devices Di (i=1 to 6)) are all reverse conducting IGBTs.

### <<Thermal Simulation>>

In order to examine a temperature rise due to heat generated in each of the first to sixth switching devices (T1 to T6) and the first to sixth diode devices (D1 to D6), thermal simulations are conducted on the semiconductor module 30 according to this embodiment when controlled in the PWM1 control mode and PWM2 control mode.

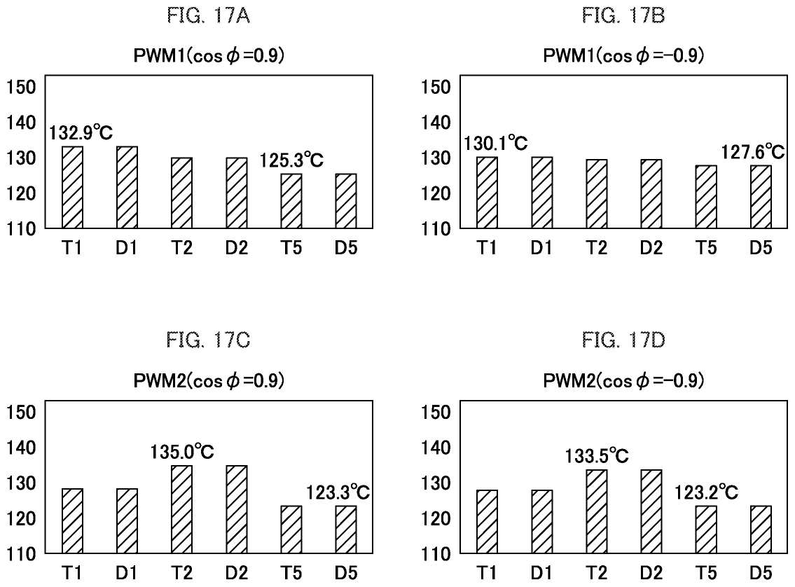

FIGS. 17A to 17D are diagrams illustrating thermal simulation results of the semiconductor module 30. FIGS. 17A to 17D show the results of temperature rises in the respective devices.

Here, only the results of the first switching device T1, the first diode device D1, the second switching device T2, the second diode device D2, the fifth switching device T5, and the fifth diode device D5 are shown.

The results of the fourth switching device T4, the fourth diode device D4, the third switching device T3, the third diode device D3, the sixth switching device T6, and the sixth diode device D6 are due to the same reason described in the first embodiment, and thus illustration thereof is omitted.

FIGS. 17A and 17B show the results of a case where the PWM1 control mode is applied to the semiconductor module 30 according to this embodiment. FIG. 17A shows the results with a power factor of 0.9, while FIG. 17B shows the results with a power factor of −0.9. FIGS. 17C and 17D show the results of a case where the PWM2 control mode is applied to the semiconductor module 30 according to this embodiment. FIG. 17C shows the results with a power factor of 0.9, while FIG. 17D shows the results with a power factor of −0.9.

When the PWM1 control mode is applied and the power factor is set to 0.9 (FIG. 17A), the first switching device T1 has the highest temperature of 132.9 degrees. The fifth switching device T5 has the lowest temperature of 125.3 degrees. Therefore, the maximum temperature difference between the devices is 7.7 degrees.

When the PWM1 control mode is applied and the power factor is set to −0.9 (FIG. 17B), the first switching device T1 has the highest temperature of 130.1 degrees. The fifth switching device T5 has the lowest temperature of 127.6 degrees. Therefore, the maximum temperature difference between the devices is 2.5 degrees.

When the PWM2 control mode is applied and the power factor is set to 0.9 (FIG. 17C), the second switching device T2 has the highest temperature of 135.0 degrees. The fifth switching device T5 has the lowest temperature of 123.3 degrees. Therefore, the maximum temperature difference between the devices is 11.7 degrees.

When the PWM2 control mode is applied and the power factor is set to −0.9 (FIG. 17D), the second switching device T2 has the highest temperature of 133.5 degrees. The fifth switching device T5 has the lowest temperature of 123.2 degrees. Therefore, the maximum temperature difference between the devices is 10.3 degrees.

In summary, under any condition, the maximum temperature difference between the devices is reduced as compared with corresponding conditions in the first and second embodiments.

From the thermal simulation results described above, the semiconductor module 30 according to this embodiment is expected to further suppress temperature variations between the devices as compared with the first or second embodiment.

### SUMMARY

As described above, the semiconductor modules 10, 20, and 30 according to the embodiments each include a plurality of parallel connection structures of switching devices and diode devices. The parallel connection structures are included in a converter circuit configured to output the AC voltage Vu from a first potential on the positive side of an input DC voltage, a second potential on the negative side, and a third potential lower than the first potential and higher than the second potential. At least one of the parallel connection structures is a reverse conducting IGBT.

According to such a configuration, when the switching device generates heat in one reverse conducting IGBT, the heat diffuses to the diode device, thereby alleviating temperature variations between the switching device and the diode device. Therefore, it is possible to suppress temperature variations between the devices included in the circuit.

In the semiconductor modules 10, 20, and 30 according to the embodiments, the first to fourth parallel connection structures are coupled in series from the first to fourth in descending order of potential between a first node to which the first potential is applied and a second node to which the second potential is applied. Among the first to fourth parallel connection structures, the parallel connection structure including a switching device that is switched with a cycle shorter than that of the AC voltage Vu is the reverse conducting IGBT. According to such a configuration, when the PWM1 control mode is applied to the semiconductor modules 10, and 30, it is possible to suppress heat generation by the switching devices which are likely to generate heat due to repeated switching.

In the semiconductor module 10 according to the first embodiment, among the first to fourth parallel connection structures, the first and fourth parallel connection structures are the reverse conducting IGBTs. According to such a configuration, when the PWM1 control mode is applied to the semiconductor module 10, heat generation by the first and fourth switching devices T1 and T4, which are likely to generate heat, can be suppressed.

In the semiconductor module 20 according to the second embodiment, among the first to fourth parallel connection structures, the second and third parallel connection structures are the reverse conducting IGBTs. According to such a configuration, when the PWM2 control mode is applied to the semiconductor module 20, heat generation by the second and third switching devices T2 and T3, which are likely to generate heat, can be suppressed.

In the semiconductor module 30 according to the third embodiment, the plurality of parallel connection structures are all the reverse conducting IGBTs. According to such a configuration, in each of the reverse conducting IGBTs, when the switching device generates heat, the heat diffuses into the diode device, thereby alleviating temperature variations between the switching device and the diode device. Therefore, it is possible to further suppress temperature variations between the devices included in the circuit.

A power converter according to an embodiment of the present disclosure includes any one of the semiconductor modules 10, 20, and 30 according to the embodiments described above. According to such a configuration, when the switching device generates heat in one reverse conducting IGBT, the heat diffuses into the diode device, thereby alleviating temperature variations between the switching device and the diode device. Therefore, it is possible to suppress temperature variations between the devices included in the circuit.

The present disclosure has been made in view of the above problems, and it is an object of the present disclosure to provide a semiconductor module capable of suppressing temperature variations between devices included in a circuit.

According to the present disclosure, a semiconductor module and a power converter which can suppress temperature variations between devices included in a circuit are provided.

The embodiments of the present disclosure described above are simply to facilitate understanding of the present disclosure and are not in any way to be construed as limiting the present disclosure. The present disclosure may variously be changed or altered without departing from its gist and encompass equivalents thereof.

What is claimed is:

1. A semiconductor module comprising:
a converter circuit configured to generate an alternating-current (AC) voltage from a direct-current (DC) voltage input thereto, by receiving
a first potential that is positive,
a second potential that is negative, and
a third potential lower than the first potential and higher than the second potential, wherein
the converter circuit includes a plurality of parallel connection structures, each parallel connection structure including an insulated gate bipolar transistors (IGBT) and a diode device connected in parallel, and
at least one of the parallel connection structures includes a reverse conducting IGBT.

2. The semiconductor module according to claim 1, wherein
the converter circuit further includes
a first node at which the first potential is received, and
a second node at which the second potential is received;
the plurality of parallel connection structures includes first to fourth parallel connection structures that are coupled in series in descending order of potential between the first node and the second node, and
at least one of the first to the fourth parallel connection structures includes the reverse conducting IGBT, and is switched with a cycle shorter than that of the AC voltage.

3. The semiconductor module according to claim 2, wherein
each of the first and the fourth parallel connection structures includes the reverse conducting IGBT.

4. The semiconductor module according to claim 2, wherein
each of the second and the third parallel connection structures includes the reverse conducting IGBT.

5. The semiconductor module according to claim 1, wherein
each of the plurality of the parallel connection structures includes the reverse conducting IGBT.

6. A power converter comprising the semiconductor module according to claim 1.
